(19) United States
(12) Patent Application Publication
(10) Pub. No.: US 2025/0052377 A1
(43) Pub. Date: Feb. 13, 2025

(54) Inner and Outer Tank Connection Device for Cryogenic Storage Tank and Cryogenic Storage Tank

(71) Applicants: Nantong CIMC Energy Equipment Co. Ltd., Nantong (CN); China International Marine Containers (Group) Co., Ltd., Shenzhen (CN); CIMC ENRIC Investment Holdings (Shenzhen) Co., Ltd., Shenzhen (CN)

(72) Inventors: Hang HAI, Nantong (CN); Yongxin LUO, Nantong (CN); Xiaoxiang ZHOU, Nantong (CN); Lin ZHAO, Nantong (CN); Ping'an JIANG, Nantong (CN); Weidong SHEN, Nantong (CN); Yunkai ZHANG, Nantong (CN); Xiaolin ZHU, Nantong (CN); Xiaofeng JU, Nantong (CN)

(73) Assignees: Nantong CIMC Energy Equipment Co. Ltd., Nantong (CN); China International Marine Containers (Group) Co., Ltd., Shenzhen (CN); CIMC ENRIC Investment Holdings (Shenzhen) Co., Ltd., Shenzhen (CN)

(21) Appl. No.: 18/721,596

(22) PCT Filed: Nov. 1, 2023
(86) PCT No.: PCT/CN2023/129148

§ 371 Date: Jun. 18, 2024

(30) Foreign Application Priority Data
Oct. 21, 2022 (CN) 202211299362.6

(51) Int. Cl. F17C 13/08; F17C 3/08

(52) U.S. Cl. CPC F17C 13/08; F17C 3/08; F17C 2203/015; F17C 2203/0629

(57) ABSTRACT

An inner and outer tank connection device for a cryogenic storage tank includes a suspension belt; a first connection assembly for connecting the outer tank, wherein the first connection assembly includes a first connection seat and a first connection member, and the first connection seat is configured for connecting the outer tank and the first connection seat is provided with a first limiting seat, the first connection member is rotatably connected to one end of the suspension belt, and the first connection member is provided with a first limiting portion, and the first limiting portion fits with the first limiting seat to limit the first connection member from twisting on the first connection seat with the suspension belt as a rotation axis; and a second connection assembly for connecting the inner tank, wherein the second connection assembly is rotatably connected to another end of the suspension belt.

### CROSS-REFERENCE TO RELATED APPLICATIONS

This application is a national stage entry under 37 U.S.C. § 371 of International Application No. PCT/CN2023/129148, filed Nov. 1, 2023, which is based upon and claims priority to Chinese Patent Application No. 202211299362.6, titled “Inner and Outer Tank Connection Device for Cryogenic Storage Tank and Cryogenic Storage Tank”, filed Oct. 21, 2022, the entire disclosure of which is incorporated herein by reference.

### TECHNICAL FIELD

The present disclosure relates to the field of cryogenic storage tank, and more particularly, to an inner and outer tank connection device for a cryogenic storage tank and a cryogenic storage tank.

### BACKGROUND

The cryogenic storage tank is a device used for storage and transportation of cryogenic medium. The liquefied gas stored and transported in industry includes liquefied natural gas, liquid oxygen, liquid nitrogen, liquid hydrogen, liquid helium and liquid argon.

The cryogenic storage tank usually includes a double-layer structure formed by an inner tank and an outer tank, and a space between the inner tank and the outer tank is a vacuum space, and the inner tank is connected to and supported in the outer tank by the inner and outer tank connection device.

In related technology, the inner tank is connected to and supported in the outer tank by setting a plurality of suspension belts, one ends of the suspension belts are fixed to the inner tank and the other ends of the suspension belts are connected to the outer tank. In the process of assembling and tightening the suspension belts, the suspension belts are prone to torsion and breakage, losing the connection and support function, resulting in a low reliability.

Thus, there is room for improvement and enhancement of the related art.

### SUMMARY

There are provided an inner and outer tank connection device for a cryogenic storage tank and a cryogenic storage tank according to embodiments of the present disclosure. The technical solution is as below:

In the first aspect, the embodiment of the present disclosure provides an inner and outer tank connection device for a cryogenic storage tank, the cryogenic storage tank including an inner tank and an outer tank, the outer tank wrapping around the inner tank, the inner and outer tank connection device for connecting the inner tank and the outer tank;
the inner and outer tank connection device includes:
a suspension belt;
a first connection assembly for connecting the outer tank, the first connection
assembly includes a first connection seat and a first connection member, and the first connection seat is configured for connecting the outer tank and the first connection seat is provided with a first limiting seat, the first connection member is rotatably connected to one end of the suspension belt, and the first connection member is provided with a first limiting portion, and the first limiting portion fits with the first limiting seat to limit the first connection member from twisting on the first connection seat with the suspension belt as a rotation axis; and
a second connection assembly for connecting the inner tank, where the second connection assembly is rotatably connected to another end of the suspension belt.

In a second aspect, the present disclosure provides a cryogenic storage tank, including an inner tank, an outer tank, and a plurality of inner and outer tank connection devices for any one of the cryogenic storage tanks as mentioned above, where the outer tank wraps around the inner tank, the inner and outer tank connection device connects the inner tank and the outer tank; and the plurality of the inner and outer tank connection devices are provided at an end portion of the inner tank, and spaced apart along a circumferential direction of the inner tank, and at least two inner and outer tank connection devices are provided on an upper side of a horizontal axis plane of the inner tank.

As can be seen from the above technical solution, the present disclosure has at least the following advantages and positive effects:

Compared with the related art, the inner and outer tank connection device of the present disclosure, the first connection assembly of the inner and outer tank connection device connects the outer tank, the second connection assembly connects the inner tank, one end of the suspension belt is rotatably connected to the first connection member of the first connection assembly, and the other end of the suspension belt is rotatably connected to the second connection assembly, and the first limiting portion on the first connection member fits with the first limiting seat of the first connection seat to limit the first connection member from twisting on the first connection seat with the suspension belt as the rotation axis, thereby preventing the suspension belt from twisting and breaking, thus the reliability of the inner and outer tank connection device and its cryogenic storage tank is improved, and two ends of the suspension belt are rotatably connected to the first connection assembly and the second connection assembly, so that when the displacement of the inner tank occurs due to thermal expansion or contraction, the suspension belt can rotate with respect to the first and second connection assemblies to reduce the force on the suspension belt caused by the displacement of the inner tank, thereby effectively preventing the suspension belt from twisting and breaking, and improving the reliability of the inner and outer tank connection device and the cryogenic storage tank.

### BRIEF DESCRIPTION OF THE DRAWINGS

FIG. 1 is a structural view of a cryogenic storage tank of the present disclosure.

FIG. 2 is a front view of FIG. 1.

FIG. 3 is a structural view of an inner and outer tank connection device of the cryogenic storage tank of the present disclosure.

FIG. 4 is a sectional view at A-A line in FIG. 3.

FIG. 5 is a partial enlarged view of a in FIG. 4.

FIG. 6 is a structural view of the inner and outer tank connection device of the cryogenic storage tank of the present disclosure viewing from another angle.

FIG. 7 is a sectional view at B-B line in FIG. 6.

FIG. 8 is a structural view showing connection between a first connection member and a suspension belt of the present disclosure.

FIG. 9 is a structural view showing connection between the first connection member and a suspension belt of the present disclosure viewing from another angle.

FIG. 10 is a structural view of connection of the second connection member to a suspension belt according to another embodiment of the present disclosure.

### DETAILED DESCRIPTION OF THE EMBODIMENTS

The present disclosure provides an inner and outer tank connection device for a cryogenic storage tank and a cryogenic storage tank. In order to make the purpose, technical program and effect of the present disclosure clearer and more explicit, the present disclosure is described in further detail hereinafter with reference to the accompanying drawings and by way of embodiments. It should be understood that the specific embodiments described herein are only for the purpose of explaining the present disclosure, and are not intended to limit the present disclosure.

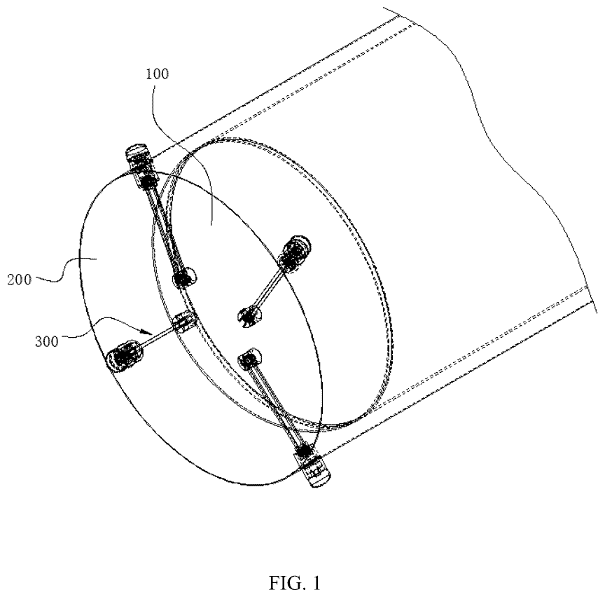

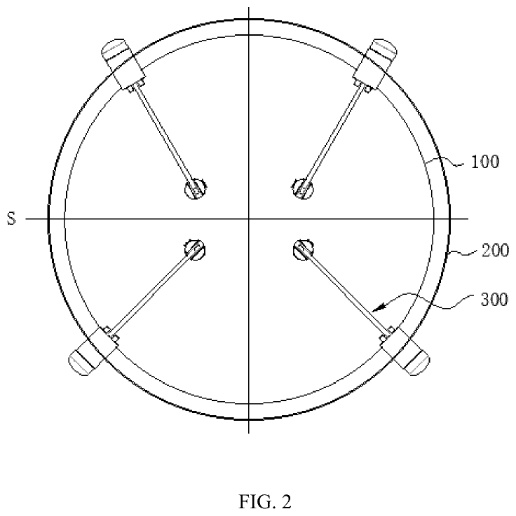

The cryogenic storage tank is a device for storing and transporting a cryogenic medium. Referring to FIGS. 1 and 2, the cryogenic storage tank includes an inner tank 100, an outer tank 200, and a plurality of inner and outer tank connection devices 300. The inner tank 100 is used to store the cryogenic medium, the outer tank 200 wraps around the inner tank 100, and a vacuum space is formed between the inner tank 100 and the outer tank 200. The inner and outer tank connection device 300 are used to connect the inner tank 100 and the outer tank 200. The plurality of inner and outer tank connection devices 300 are provided at an end of the inner tank 100, and spaced apart along a circumferential direction of the inner tank 100, and at least two inner and outer tank connection devices 300 are provided at an upper side of a horizontal axis plane of the inner tank 100. Each inner and outer tank connection device 300 connects the inner tank 100 and the outer tank 200 and supports the inner tank 100 in the outer tank 200. The horizontal axis plane of the inner tank 100 is horizontal and passes through the axis of the inner tank 100, such as the plane S in FIG. 2.

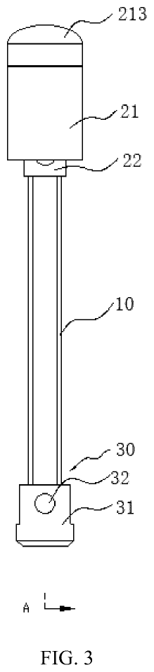

Referring to FIGS. 2 to 4, each the inner and outer tank connection device 300 of the cryogenic storage tank includes a suspension belt 10, a first connection assembly 20, and a second connection assembly 30.

One end of the suspension belt 10 is rotatably connected to the first connection assembly 20 and the other end of the suspension belt 10 is rotatably connected to the second connection assembly 30. When the displacement of the inner tank 100 occurs due to thermal expansion and contraction, the rotatably connected suspension belt 10 can reduce pulling force of the suspension belt 10 caused by the displacement of the inner tank 100, thereby reducing the possibility of damage to the suspension belt 10.

The suspension belt 10 is made of a fiber-reinforced resin composite material. The fibers in the fiber-reinforced resin composite material may be carbon fibers, aramid fibers, or glass fibers. The resin may be an epoxy resin, a polyamide resin, or a high-density polyethylene resin. Due to the low thermal conductivity of the fiber-reinforced resin composite material, the suspension belt 10 has a small thermal conductivity and is resistant to low temperature, fatigue, and high reliability.

The temperature of the cryogenic medium stored in the cryogenic storage tank is generally not less than −196° C., which is the liquefaction temperature of liquid nitrogen, whereas the temperature of an ultra-low temperature medium reaches below −253° C. As the liquid hydrogen and liquid helium medium have a low boiling point, low density, and a small latent heat of vaporization, the cryogenic storage tank is required to have stronger thermal insulation performance. Taking the tank of the same structure as an example, the standard heat leakage of the tank filled with the liquid hydrogen is 1.16 times that of the tank filled with liquid nitrogen, static evaporation rate of the tank filled with the liquid hydrogen is 5.87 times that of the tank filled with the liquid nitrogen. There are three main aspects of heat leakage from insulation of cryogenic storage tanks: the heat leakage from supports of the inner and outer tank 300, heat leakage from an insulation layer, and heat leakage from pipeline. The suspension belt 10 in the present disclosure is made of a fiber-reinforced resin composite material with a small coefficient of thermal conductivity, which can effectively reduce the heat leakage from the supports of the inner and outer tank connection device 300 and improve the thermal insulation performance of the cryogenic storage tank.

Referring to FIGS. 2 to 4, the first connection assembly 20 connects the outer tank 200. The first connection assembly 20 includes a first connection seat 21 and a first connection member 22. The first connection seat 21 connects the outer tank 200. The first connection seat 21 is provided with a first limiting seat 211. The first connection member 22 is rotatably connected to one end of the suspension belt 10. The first connection member 22 is provided with a first limiting portion 221. The first limiting portion 221 fits with the first limiting seat 211, so that the first connection member 22 is limited in the first limiting seat 211 to limit the first connection member 22 from twisting in the first connection seat 21 with the suspension belt 10 as the rotation axis, thereby preventing the suspension belt 10 from twisting and breaking, and improving the reliability of the inner and outer tank connection device 300.

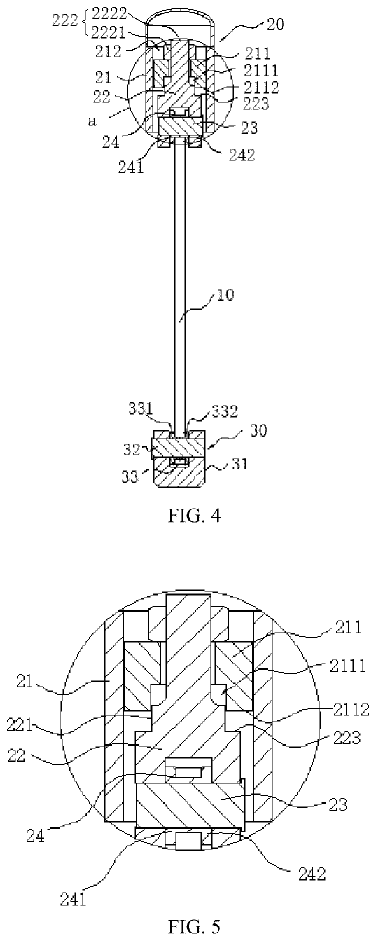

Referring to FIGS. 4 and 5, a limiting guide groove 2111 is provided in the first limiting seat 211, and a first limiting portion 221 fits with the limiting guide groove 2111. Since the first limiting portion 221 fits with the limiting guide groove 2111 to limit the first connection member 22 from twisting in the first connection seat 21 with the suspension belt 10 as the rotation axis, thereby effectively preventing the suspension belt 10 from twisting and breaking.

The first connection member 22 is provided with an adjusting structure 222, which drives the first limiting portion 221 to move along the limiting guide groove 2111 for adjusting the distance between the first connection member 22 and the second connection assembly 30, and applying a pre-tightening force to the suspension belt 10. A worker may adjust the position of the first limiting portion 221 in the limiting guide groove 2111 by the adjusting structure 222, to adjust the distance between the first connection member 22 and the second connection assembly 30, and to adjust the looseness and tightness of the suspension belt 10. A pre-tightening force is applied to the suspension belt 10, so as to keep the suspension belt 10 in a tensile state, and facilitate the assembly.

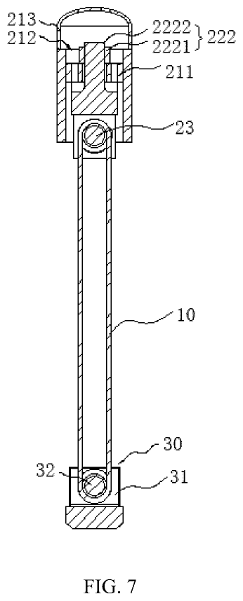

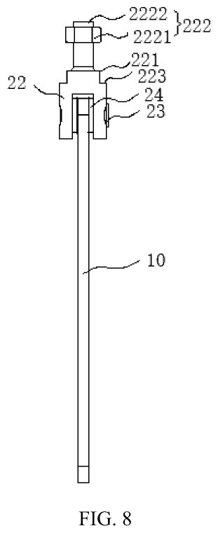

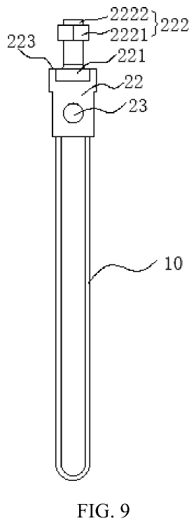

Referring to FIGS. 4, 5, and 7 to 9, the adjusting structure 222 includes an adjusting nut 2221 and an adjusting screw 2222. The adjusting screw 2222 projects from the first connection member 22 and passes through the limiting guide groove 2111. The adjusting screw 2222 fits with the adjusting nut 2221, so that the adjusting screw 2222 can drive the first limiting portion 221 to move along the limiting guide groove 2111, to adjust the distance between the first connection member 22 and the second connection assembly 30, and apply a pre-tightening force to the suspension belt 10.

Specifically, when the adjusting nut 2221 fits with the adjusting screw 2222 to be tightened, the adjusting screw 2222 passes through the adjusting nut 2221 and protrudes from the adjusting nut 2221 to shorten the distance between the first connection member 22 and the second connection assembly 30, to tighten the suspension belt 10; when the adjusting nut 2221 rotates in the opposite direction, the adjusting screw 2222 is retracted in the opposite direction, to increase the distance between the first connection member 22 and the second connection assembly 30, such that the suspension belt 10 changes from a tightened state to a relaxed state. The limiting guide groove 2111 limits the first limiting portion 221 from twisting, while guides the movement of the convex extension and retraction of the adjusting screw 2222.

In this embodiment, a locking protrusion 2112 is provided convexly in the first limiting seat 211. A locking table 223 is provided on the first connection member 22. When the distance between the first connection member 22 and the second connection assembly 30 is adjusted to be a maximum, the locking table 223 abuts against the locking protrusion 2112. The locking table 223 abuts against the locking projection 2112 to limit the maximum distance between the first connection member 22 and the second connection assembly 30, so as not to overstretch the suspension belt 10, thereby further improving the reliability of the inner and outer tank connection device 300.

The limiting guide groove 2111 is provided on the locking projection 2112, and the adjusting screw 2222 passes through the limiting guide groove 2111. One of the two opposite sides of the locking projection 2112 abuts against the locking table 223, and the other side abuts against the adjusting nut 2221. The adjusting nut 2221 fits with the adjusting screw 2222 to rotate, such that the adjusting screw 2222 extends out the locking projection 2112 or retracts the locking projection 2112, to adjust the position of the first limiting portion 221 in the limiting guide groove 2111.

In other embodiments, first through holes may be provided on the first connection member 22 and a plurality of second through holes on the first connection seat 21. The first through holes on the first connection member 22 are adjusted to align with the second holes at different positions, the first connection member 22 is fixed by screws passing through the first through holes and the second through holes, to adjust the position of the first connection member 22 in the limiting guide groove 2111, and adjust the distance between the first connection member 22 and the second connection assembly 30. In this embodiment, the adjusting screw 2222 is used to fit with the adjusting nut 2221, which is simple in structure and more convenient in operation.

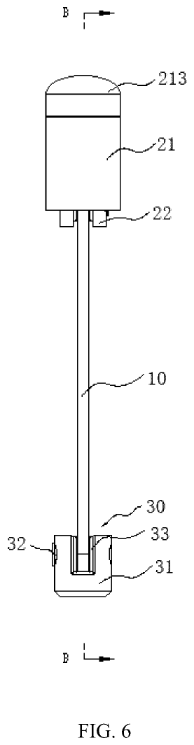

Referring to FIGS. 4 to 7, an opening 212 and a sealing plate 213 may be provided on the side of the first connection seat 21 away from the suspension belt 10. When the suspension belt 10 is adjusted to a suitable looseness or tightness through the cooperation of the adjusting screw 2222 and the adjusting nut 2221, the sealing plate 213 is covered on the opening 212, to seal the side of the first connection seat 21 away from the suspension belt 10.

Referring to FIGS. 4, 8 and 9, the suspension belt 10 is in the form of a ring. The first connection assembly 20 further includes a first pin 23. The first pin 23 passes through the first connection member 22. One end of the suspension belt 10 is sleeved on the first pin 23 and is rotatable about the first pin 23. The first pin 23 has a pre-tensioning function for the suspension belt 10.

The first connection assembly 20 may also include a first shaft sleeve 24, one end of the suspension belt 10 is sleeved on the first pin 23 via the first shaft sleeve 24. The first shaft sleeve 24 can reduce the friction force of the suspension belt 10 rotating about the first pin 23 and reduce the wear and tear of the suspension belt 10.

The first shaft sleeve 24 is provided with a first stop portion 241 and a second stop portion 242. The first stop portion 241 and the second stop portion 242 are spaced apart along the axis of the first pin 23. One end of the suspension belt 10 is sleeved between the first stop portion 241 and the second stop portion 242 for preventing the suspension belt 10 from slipping along the axis of the first pin 23, thereby improving the connection stability of the inner and outer tank connection device 300.

The second connection assembly 30 includes a second connection member 31 and a second pin 32. The second connection member 31 is connected to the inner tank 100. The second pin 32 is passed through the second connection member 31 and is provided parallel to the first pin 23. The other end of the suspension belt 10 is sleeved on the second pin 32 and is rotatable about the second pin 32. The second pin 32 has a pre-tensioning function for the suspension belt 10.

Since the suspension belt 10 is rotatable about the first pin 23 and the second pin 32, such that the suspension belt 10 can rotate to reduce the pulling force of the inner tank 100 on the suspension belt 10 when the displacement of the inner tank 100 occurs due to thermal expansion and contraction, the possibility of breakage of the suspension belt 10 is reduced.

The second connection assembly 30 may also include a second shaft sleeve 33, one end of the suspension belt 10 is sleeved on the second pin 32 via the second shaft sleeve 33. The second shaft sleeve 33 reduces the friction force of the suspension belt 10 rotating about the first pin 23 and reduces the wear and tear of the suspension belt 10.

The second shaft sleeve 33 is provided with a third stop portion 331 and a fourth stop portion 332. The third stop portion 331 and the fourth stop portion 332 are spaced apart along the axis of the second pin 32. The other end of the suspension belt 10 is sleeved between the third stop portion 331 and the fourth stop portion 332 for preventing the suspension belt 10 from sliding along the axis of the second pin 32, thereby improving the connection stability of the inner and outer tank connection device 300.

When the adjusting screw 2222 of the adjusting structure 222 fits with the adjusting nut 2221 to drive the first limiting portion 221 to move in the limiting guide groove 2111, the distance between the first connection member 22 and the second connection assembly 30 is adjusted, i.e., the distance between the first pin 23 and the second pin 32 is adjusted to adjust the looseness or tightness of the suspension belt 10.

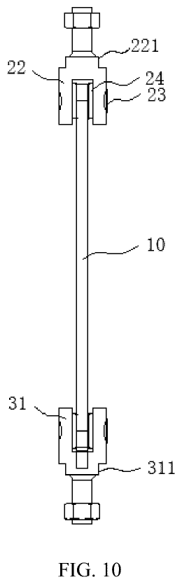

In another embodiment, referring to FIG. 10, the structure of the second connection assembly 30 may be the same as the structure of the first connection assembly 20. The second connection assembly 30 further includes a second connection seat. The second connection member 31 is fixedly connected to the inner tank 100 via the second connection seat. The second connection seat is provided with a second limiting seat. The second connection member 31 is provided with a second limiting portion 311, and the second limiting portion 311 fits with the second limiting seat to limit the second connection member 31 from twisting on the second connection seat with the suspension belt 10 as the rotation axis.

In the present disclosure, the first connection assembly 20 of the inner and outer tank connection device 300 connects the outer tank 200, the second connection assembly 30 connects the inner tank 100, one end of the suspension belt 10 is rotatably connected to the first connection member 22 of the first connection assembly 20, and the other end of the suspension belt 10 is rotatably connected to the second connection assembly 30, and the first limiting portion 221 on the first connection member 22 fits with the first limiting seat 211 of the first connection seat 21 to limit the first connection member 22 from twisting on the first connection seat 21 with the suspension belt 10 as the rotation axis, thereby preventing the suspension belt 10 from twisting and breaking, and improving the reliability of the inner and outer tank connection device 300 and the cryogenic storage tank, and two ends of the suspension belt 10 are rotatably connected to the first connection assembly 20 and the second connection assembly 30, when the displacement of the inner tank 100 occurs due to thermal expansion and contraction, the suspension belt 10 can rotate relative to the first connection assembly 20 and the second connection assembly 30, to reduce the force on the suspension belt 10 caused by the displacement of the inner tank 100, thereby effectively preventing the suspension belt 10 from breaking, and improving the reliability of the inner and outer tank connection device 300 and the cryogenic storage tank.

It should be understood that equivalent substitutions or alterations may be made for those skilled in the art in accordance with the technical solution of the present disclosure and its inventive concept, and all such alterations or substitutions shall fall within the scope of protected by the claims of the present disclosure.

1. An inner and outer tank connection device for a cryogenic storage tank, the cryogenic storage tank comprising an inner tank and an outer tank, the outer tank wrapping around the inner tank;
wherein the inner and outer tank connection device comprises:
a suspension belt;
a first connection assembly for connecting to the outer tank, wherein the first connection assembly comprises a first connection seat and a first connection member, and the first connection seat is configured for connecting the outer tank and the first connection seat is provided with a first limiting seat, wherein the first connection member is rotatably connected to one end of the suspension belt, and the first connection member is provided with a first limiting portion, and the first limiting portion fits with the first limiting seat to limit the first connection member from twisting on the first connection seat with the suspension belt as a rotation axis; and
a second connection assembly for connecting to the inner tank, wherein the second connection assembly is rotatably connected to another end of the suspension belt.

2. The inner and outer tank connection device according to claim 1, wherein the first limiting seat is provided with a limiting guide groove fitting with the first limiting portion, and the first connection member is provided with an adjusting structure for driving the first limiting portion to move along the limiting guide groove to adjust a distance between the first connection member and the second connection assembly.

3. The inner and outer tank connection device according to claim 2, wherein the adjusting structure comprises an adjusting nut and an adjusting screw projected from the first connection member, wherein the adjusting screw is passed through the limiting guide groove, and the adjusting screw fits with the adjusting nut to enable the adjusting screw to drive the first limiting portion to move along the limiting guide groove to adjust the distance between the first connection member and the second connection assembly.

4. The inner and outer tank connection device according to claim 3, wherein a locking projection is provided convexly in the first limiting seat, and the first connection member is provided with a locking table, wherein the locking table is abutted against the locking projection when the distance between the first connection member and the second connection assembly is adjusted to a maximum.

5. The inner and outer tank connection device according to claim 2, wherein the first connection member is provided with a first through hole, the first connection seat is provided with a plurality of second through holes, and the first through hole on the first connection member is aligned with the second through holes in different positions; and
wherein the first connection member is fixed by a screw passing through the first through hole and the second through hole to adjust the distance between the first connection member and the second connection assembly.

6. The inner and outer tank connection device according to claim 1, wherein the suspension belt is in the form of a ring, wherein the first connection assembly further comprises a first pin, and the first pin is passed through the first connection member;
wherein the second connection assembly comprises a second connection member and a second pin, and the second connection member is fixed to the inner tank; and
wherein the second pin is passed through the second connection member and is provided parallel to the first pin, and two ends of the suspension belt are sleeved on the first pin and the second pin, and are rotatable about the first pin and the second pin.

7. The inner and outer tank connection device according to claim 6, wherein the first connection assembly further comprises a first shaft sleeve, and the second connection assembly further comprises a second shaft sleeve, wherein one end of the suspension belt is sleeved on the first pin through the first shaft sleeve, and another end of the suspension belt is sleeved on the second pin through the second shaft sleeve.

8. The inner and outer tank connection device according to claim 7, wherein the first shaft sleeve is provided with a first stop portion and a second stop portion, wherein the first stop portion and the second stop portion are spaced apart along an axis of the first pin, and an end of the suspension belt is sleeved between the first stop portion and the second stop portion, and wherein the second shaft sleeve is provided with a third stop portion and a fourth stop portion, wherein the third stop portion and the fourth stop portion are spaced apart along an axis of the second pin, and another end of the suspension belt is sleeved between the third stop portion and the fourth stop portion.

9. The inner and outer tank connection device according to claim 6, wherein the second connection assembly further comprises a second connection seat, the second connection seat is provided with a second limiting seat, and the second connection member is provided with a second limiting portion, wherein the second limiting portion fits with the second limiting seat to limit the second connection member from twisting on the second connection seat with the suspension belt as the rotation axis, and the second connection member is connected to the inner tank through the second connection seat.

10. The inner and outer tank connection device according to claim 1, wherein the suspension belt is made of a fiber-reinforced resin composite material.

11. The inner and outer tank connection device according to claim 10, wherein fibers in the fiber-reinforced resin composite material are carbon fibers, aramid fibers or glass fibers, wherein a resin in the fiber-reinforced resin composite material is an epoxy resin, a polyamide resin or a high-density polyethylene resin.

12. A cryogenic storage tank, comprising an inner tank, an outer tank, and an inner and outer tank connection devices according to claim 1, wherein the outer tank wraps around the inner tank, and wherein the inner and outer tank connection device connects the inner tank and the outer tank; and
wherein the inner and outer tank connection device is provided at an end portion of the inner tank.

13. The cryogenic storage tank according to claim 12, wherein the first limiting seat is provided with a limiting guide groove fitting with the first limiting portion, and the first connection member is provided with an adjusting structure for driving the first limiting portion to move along the limiting guide groove to adjust a distance between the first connection member and the second connection assembly.

14. The cryogenic storage tank according to claim 13, wherein the adjusting structure comprises an adjusting nut and an adjusting screw projected from the first connection member, wherein the adjusting screw is passed through the limiting guide groove, and the adjusting screw fits with the adjusting nut to enable the adjusting screw to drive the first limiting portion to move along the limiting guide groove to adjust the distance between the first connection member and the second connection assembly.

15. The cryogenic storage tank according to claim 14, wherein a locking projection is provided convexly in the first limiting seat, and the first connection member is provided with a locking table, wherein the locking table is abutted against the locking projection when the distance between the first connection member and the second connection assembly is adjusted to a maximum.

16. The cryogenic storage tank according to claim 13, wherein the first connection member is provided with a first through hole, the first connection seat is provided with a plurality of second through holes, and the first through hole on the first connection member is aligned with the second through holes in different positions; and
wherein the first connection member is fixed by a screw passing through the first through hole and the second through hole to adjust the distance between the first connection member and the second connection assembly.

17. The cryogenic storage tank according to claim 14, wherein an opening and a sealing plate are provided on a side of the first connection seat far away from the suspension belt; and
when the suspension belt is adjusted by the adjusting screw fitting with the adjusting nut, the opening is covered by the sealing plate to seal the side of the first connection seat far away from the suspension belt.

18. The cryogenic storage tank according to claim 15, wherein the limiting guide groove is provided on the locking projection, and the adjusting screw is threaded through the limiting guide groove; wherein one of two opposite sides of the locking projection is abutted against the locking table, and other side of two opposite sides of the locking projection is abutted against the adjusting nut.

19. The cryogenic storage tank according to claim 12, comprising a plurality of inner and outer tank connection devices provided at the end portion of the inner tank and spaced apart along a circumferential direction of the inner tank.

20. The cryogenic storage tank according to claim 12, comprising at least two inner and outer tank connection devices provided on an upper side of a horizontal axis plane of the inner tank.
